(19) United States
(12) Patent Application Publication
(10) Pub. No.: US 2008/0164808 A1
(43) Pub. Date: Jul. 10, 2008

(54) Organic light emitting display device and manufacturing method of the same

(76) Inventors: Tae-woong Kim, Suwon-si (KR); Kyu-sung Lee, Suwon-si (KR); Jin-ho Kwack, Suwon-si (KR); Dong-un Jin, Suwon-si (KR); Yeon-gon Mo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/880,185

(22) Filed: Jul. 19, 2007

(30) Foreign Application Priority Data
Jan. 5, 2007 (KR) 10-2007-0001343

(51) Int. Cl. H05B 33/00; B05D 5/12

(52) U.S. Cl. 313/504; 427/66

(57) ABSTRACT

An organic light emitting display device and a manufacturing method of forming an inorganic layer formed on the top of the sealing film with nitride are disclosed. In one embodiment, the organic light emitting display device includes: i) a substrate on which at least one organic light emitting diode is formed and ii) a sealing film stacked with at least one organic film and inorganic film and sealing the organic light emitting diode, wherein the top of the sealing film is formed of an inorganic film formed of nitride.

### CROSS-REFERENCE TO RELATED APPLICATIONS

This application claims the benefit of Korean Patent Application No. 10-2007-0001343, filed on Jan. 5, 2007, in the Korean Intellectual Property Office, the disclosure of which is incorporated herein by reference.

### BACKGROUND OF THE INVENTION

1. Field of the Invention

The present invention relates to an organic light emitting display device sealing an organic light emitting diode with a sealing film, and more particularly to an organic light emitting display device and a manufacturing method of the same.

2. Discussion of Related Technology

An organic light emitting display device is a self-emission type display electrically exciting and emitting phosphoric organic compound. The organic light emitting display device has been spotlighted as a next generation display due to the advantages of low voltage driving, thinness, a wide viewing angle and rapid response, etc.

### SUMMARY OF CERTAIN INVENTIVE ASPECTS

One aspect of the present invention improves anti-scratch characteristics on the surface of a sealing film by forming the inorganic film formed on the top of the sealing film with nitride.

Another aspect of the present invention provides an organic light emitting display device including i) a substrate on which at least one organic light emitting diode is formed and ii) a sealing film stacked with at least one organic film and inorganic film and sealing the organic light emitting diode, wherein the top of the sealing film is formed of an inorganic film formed of nitride.

Another aspect of the present invention provides a manufacturing method of an organic light emitting display device including: i) preparing a substrate on which at least one organic light emitting diode is formed, ii) sequentially forming at least one organic film and inorganic film so that they cover the organic light emitting diode on the substrate and iii) forming the inorganic film of nitride on the organic film.

Another aspect of the invention provides an organic light emitting display device comprising: i) a substrate, ii) at least one organic light emitting diode formed on the substrate and iii) a sealing film configured to prevent at least one of moisture and oxygen from contacting the at least one organic light emitting diode, wherein the sealing film comprises at least one organic layer and at least one inorganic layer, wherein the sealing film comprises a top layer, which is the farthest from the substrate among the layers of the sealing film, and wherein the top layer comprises a nitride material.

In the above device, the nitride material may be at least one selected from a group consisting of SiN, SiOₓN_{y} and AlOₓN_{y}. In the above device, the at least one organic layer may comprise at least one selected from a group consisting of epoxy, acrylate and urethane acrylate. In the above device, the sealing film may further comprise a side layer extending from the top layer and toward the substrate.

In the above device, the top layer may comprise a plurality of sublayers stacked together, wherein at least part of the plurality of sublayers comprise a nitride material. In the above device, the top layer may have a thickness of about 0.1 μm to about 1.05 μm. The above device may further comprise a protective film between the organic light emitting diode and the sealing film. In the above device, the top layer may have a thickness of about 0.05 μm to about 0.1 μm.

In the above device, the sealing film may comprise: a first organic layer formed over the at least one organic light emitting diode, a first inorganic layer formed on the first organic layer, a second organic layer formed on the first inorganic layer and a second inorganic layer formed on the second organic layer. In the above device, the sealing film may have a thickness of about 1 μm to about 10 μm. In the above device, the sealing film may comprise two or more inorganic layers, wherein at least one organic layer is interposed between two of the inorganic layers.

Still another aspect of the invention provides a method of manufacturing an organic light emitting display device comprising: i) providing a substrate and at least one organic light emitting diode formed on the substrate and ii) forming a film over the at least one organic light emitting diode, wherein the film comprises at least one organic layer and at least one organic layer, wherein the film comprises a top layer which is the farthest from the substrate among the layers of the film, and wherein the top layer comprises a nitride material.

In the above method, the nitride material is at least one selected from a group consisting of SiN, SiOₓN_{y} and AlOₓN_{y}. The above method may further comprise forming a protective film over the at least one organic light emitting diode, wherein the protective film is interposed between the at least one organic light emitting diode and the film. In the above method, forming of the film may comprise: forming a first organic layer over the at least one organic light emitting diode, forming a first inorganic layer on the first organic layer, forming a second organic layer on the first inorganic layer and forming a second inorganic layer on the second organic layer.

Yet another aspect of the invention provides an organic light emitting display device comprising: i) a substrate, ii) an array of organic light emitting diodes formed on the substrate, wherein the array comprises a top surface and side surfaces; wherein the top surface faces away from the substrate, and wherein the side surfaces interconnect the top surface and the substrate and iii) a film, formed over the array, configured to prevent at least one of moisture and oxygen from contacting the array, wherein the film comprises at least one layer, which comprises a nitride material, and wherein the at least one layer comprising the nitride material has a Pencil Hardness value of HB or harder.

In the above device, the nitride material may be at least one selected from a group consisting of SiN, SiOₓN_{y} and AlOₓN_{y}. In the above device, the top layer may have a thickness of about 0.05 μm to about 1.05 μm. In the above device, the Pencil Hardness value may be about 9H. In the above device, the film may comprise a side layer covering at least part of the side surfaces of the array, wherein the side layer extends from the top layer.

### BRIEF DESCRIPTION OF THE DRAWINGS

Embodiments of the invention will be described in conjunction with the accompanying drawings.

FIG. 1 is a cross-sectional view of a typical organic light emitting display device using a sealing film.

FIG. 2 is a cross-sectional view of an organic light emitting display device according to a first embodiment of the present invention.

FIG. 3 is a cross-sectional view of an organic light emitting display device according to a second embodiment of the present invention.

FIG. 4 is a cross-sectional view of an organic light emitting display device according to a third embodiment of the present invention.

FIG. 5 is a cross-sectional view of an organic light emitting display device according to a fourth embodiment of the present invention.

### DETAILED DESCRIPTION OF EMBODIMENTS

When the light emitting layer of the organic light emitting diode is exposed to moisture and oxygen, the light emitting layer is damaged. Therefore, in order to prevent the light emitting diode from being damaged with moisture and oxygen, sealing means is generally provided on the substrate on which the organic light emitting diode is formed. Such sealing means can comprise a sealing substrate or a sealing film.

The sealing substrate can be formed of glass or metal, wherein it is bonded to the substrate by applying an adhesive member to the outer region of the sealing substrate. Thereafter, the adhesive member is cured by irradiating UV on the sealing substrate to which the adhesive member is applied.

Meanwhile, the sealing film, which is formed by alternately stacking a plurality of inorganic films and organic films on the substrate on which the organic light emitting diode is formed, is formed with a thickness of about 1 to about 10 μm so that it can make the organic light emitting display device thin.

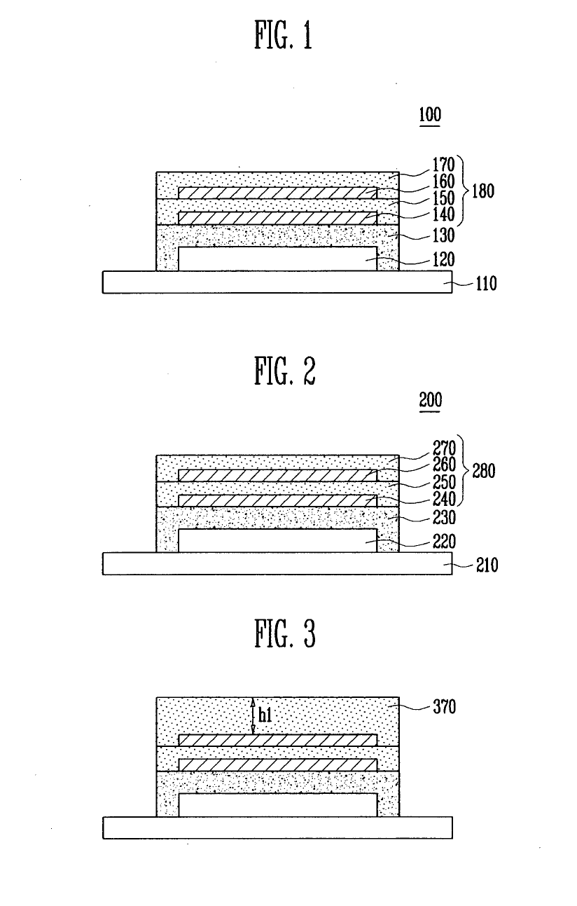

FIG. 1 is a cross-sectional view of a typical organic light emitting display device using a sealing film. The organic light emitting display device 100 may include a substrate 110 on which an organic light emitting diode 120 is formed, a protective film 120 formed on the substrate, and a sealing film 180 formed on the protective film 120.

The sealing film 180 may be formed of plural layers by alternately stacking at least one inorganic film (layer) and at least one organic film (layer) so that the infiltration of moisture and oxygen to the organic light emitting diode 120 is prevented. For example, the sealing film 180 is formed by alternately stacking a first organic film 140, a first inorganic film 150, a second organic film 160 and a second inorganic film 170. At this time, the first organic film 140 and the second organic film 160 are formed of one selected from a group consisting of epoxy, acrylate and urethane acrylate, and the first inorganic film 150 and the second inorganic film 170 are formed of one selected from a group consisting of AlOₓ and SiOₓ.

However, the second inorganic film 170 formed of oxide has low hardness so that the surface of the second inorganic film 170 can be easily scratched due to external impact or pressure. As described above, scratches occur on the surface of the second inorganic film 170 formed on the top of the sealing film 180, causing a problem that dark spots are generated in an image.

Hereinafter, embodiments of the present invention will be described with reference to the accompanying drawings.

FIG. 2 is a cross-sectional view of an organic light emitting display device according to a first embodiment of the present invention.

In one embodiment, the organic light emitting display device 200 includes a substrate 200 on which at least one organic light emitting diode 220 is formed and a sealing film 280 stacked with at least one organic film and inorganic film and sealing the organic light emitting diode 220, wherein the top of the sealing film 280 is formed of an inorganic film 270 formed of nitride.

A plurality of organic light emitting diodes 220 are formed on the substrate 210. The organic light emitting diode 220 includes an anode electrode, a light emitting layer and a cathode electrode, wherein the anode electrode is electrically connected to the drain electrode of a thin film transistor formed in a bottom surface of an opening portion of a pixel defined layer, the light emitting layer is stacked on the upper of the anode electrode and the cathode electrode is formed on the light emitting layer and the pixel defined layer.

In such an organic light emitting diode, when a predetermined voltage is applied to the anode electrode and the cathode electrode, holes injected from the anode electrode are moved to the light emitting layer via a hole transporting layer forming the light emitting layer, and electrons injected from the cathode electrode are injected to the light emitting layer via an electron transporting layer. At this time, the electrons and holes are re-coupled to generate an exciton, and a phosphoric molecule is light emitted as the exciton is changed from an excitation state to a base station so that an image is formed.

In one embodiment, a protective film 230 is formed on the substrate 210. The protective film 230, which is deposited to cover the substrate 210 on which the organic light emitting diode 220 is formed, can be formed of inorganic compound. Such a protective film 230 may be formed of a thick inorganic film on the substrate 210 so that it allows the surface contacting the organic light emitting diode 220 formed on the substrate 210 to be planarized, thereby improving the adhesive force between the substrate 210 and the sealing film 280.

Also, the sealing film 280 including at least one layer of the organic film and inorganic film is formed in order to prevent the infiltration of moisture and oxygen to the organic light emitting diode 220. The sealing film 280 can be formed by alternately stacking the organic film and the inorganic film. The thickness of the sealing film 280 may be about 1 to about 10 μm so that it can approximately be reduced by 1/30 as compared to the sealing substrate having a thickness of about 200 μm or more used in a general organic light emitting display device.

For example, a first organic film 240, a first inorganic film 250, a second organic film 260 and a second inorganic film 270 are formed by being alternately repeated four times on the protective film 230. This is to more efficiently block oxygen and moisture, which can be infiltrated from the external. Also, the first and the second organic films 240 and 260 of the sealing film 280 prevent the defect of nanocracks and microcracks formed on the first and the second inorganic films 250 and 270 from being continuously generated so that the infiltration path of moisture and oxygen is extended to lower vapor permeability and to reduce stress maintained in the first and the second inorganic films 250 and 270. Also, the first and the second inorganic films 250 and 270 can prevent the infiltration of the moisture and the oxygen.

The first organic film 240 and the second organic film 260 can be formed of at least one selected from a group consisting of epoxy, acrylate and urethane acrylate.

In one embodiment, the second inorganic film 270 formed on the top of the sealing film 280 is formed of nitride having higher film density than oxide. This reason is that the hardness of the oxide film formed on the top of a general sealing film is lower than that of nitride film.

Table 1 indicates the examination value of pencil hardness according to oxide and nitride.

TABLE 1

| Material | Value of Pencil Hardness |
|---|---|
| Oxide | 6B to 1B |
| Nitride (SiNₓ) | 9H |

As can be appreciated from Table 1, the oxide has lower hardness than the nitride. For example, the value of pencil hardness of the oxide is 3B on the average, while the value of pencil hardness of the nitride is 9H, which is significantly harder than 6B-1B. The value of hardness is lowered in the order of H>F>HB>B.

More specifically, when the oxide is Al₂O₃ (100 nm), the value of pencil hardness is 6B; when the oxide is AR coating film PET (150 μm), the value of pencil hardness is 2B; when the oxide is SiO₂ (100 nm), the value of pencil hardness is 2B; and when the nitride is SiN (100 nm), the value of pencil hardness is 9H.

According to the result of the examination, it can be appreciated that the hardness of the nitride film is significantly higher than that of the oxide film.

As described above, the top layer of the sealing film 280 is formed of a nitride film 270 so that anti-scratch characteristics formed on the surface of the nitride film 270 due to external impact or pressure are improved.

Such a nitride film 270 can be formed of one or more substances selected from a group consisting of SiN, SiOₓN_{y} and AlOₓN_{y}.

Also, depending on the material of the nitride film 270, an ion beam assisted sputtering, an E-beam deposition, a plasma enhanced chemical vapor deposition (PECVD), a RF sputtering and an atomic layer deposition, etc. can be used.

FIG. 3 is a cross-sectional view of an organic light emitting display device according to a second embodiment of the present invention.

The FIG. 3 embodiment is identical with the first embodiment of the present invention except that it increases the thickness h1 of a nitride film 370 by about 0.05 to about 1 μm as compared to the thickness about 0.05 μm of the existing nitride film (270 in FIG. 2) by more stacking one or two nitride film on the existing nitride film, forming the thickness h1 of the nitride film 370 to the extent of about 0.1 to about 1.05 μm.

The thickness of the nitride film 370 is formed to be thicker than that in the first embodiment, making it possible to additionally improve the anti-scratch characteristics on the surface of the nitride film 370 by additionally increasing the hardness.

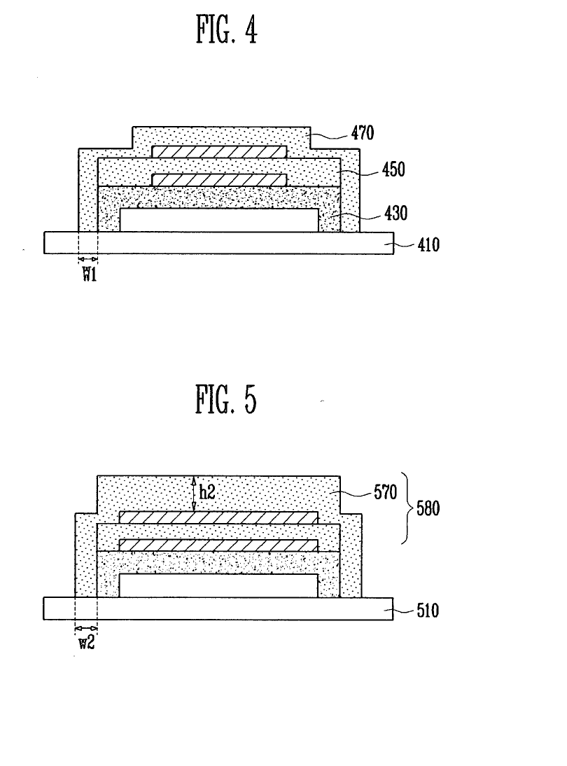

FIG. 4 is a cross-sectional view of an organic light emitting display device according to a third embodiment of the present invention.

The FIG. 4 embodiment is identical with the first embodiment of the present invention except that it further forms W1 a nitride film 470 on a substrate 410 to further form a contact area between the nitride film 470 and the substrate 410. As such, the peel-off phenomenon of the nitride film 470 can be prevented by contacting the substrate 410 with the nitride film 470. Also, the nitride film 470 is further formed on the sides of the protective film 430 and the first inorganic film 450 so that it can more efficiently prevent the moisture and the oxygen which can be infiltrated between the protective film 430 and the first inorganic film 450, and between the first inorganic film 450 and the nitride film 470.

FIG. 5 is a cross-sectional view of an organic light emitting display device according to a fourth embodiment of the present invention.

The FIG. 5 embodiment is identical with the first embodiment of the present invention except that it increases the thickness h2 of a nitride film 570 by about 0.05 to about 1 μm as compared to the thickness about 0.05 μm of the existing nitride film (270 in FIG.2 ), forming the thickness h2 of the nitride film 570 to the extent of about 0.1 to about 1.05 μm, and forms the nitride film 570 to be wider W2 on the substrate 510, forming the contact area between the nitride 570 and the substrate 510 to be wider. The thickness of the nitride 570 is formed to be thicker than that in the first embodiment and the contact area between the substrate 510 and the nitride 570 is to be wider, making it possible to improve the anti-scratch characteristics on the surface of the nitride film 570 by increasing the hardness of the nitride film 570 and reducing the peel-off phenomenon of a thin film 580 by improving the adhesion between the substrate 510 and the thin film 580.

As described above, according to embodiments of the present invention, the inorganic layer formed on the top of the sealing film is formed of the nitride film so that the anti-scratch characteristics on the surface of the sealing film are improved.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An organic light emitting display device comprising:
a substrate;
at least one organic light emitting diode formed on the substrate; and
a sealing film configured to prevent at least one of moisture and oxygen from contacting the at least one organic light emitting diode, wherein the sealing film comprises at least one organic layer and at least one inorganic layer,
wherein the sealing film comprises a top layer, which is the farthest from the substrate among the layers of the sealing film, and wherein the top layer comprises a nitride material.

2. The organic light emitting display device as claimed in claim 1, wherein the nitride material is at least one selected from a group consisting of SiN, SiOₓN_{y} and AlOₓN_{y}.

3. The organic light emitting display device as claimed in claim 1, wherein the at least one organic layer comprises at least one selected from a group consisting of epoxy, acrylate and urethane acrylate.

4. The organic light emitting display device as claimed in claim 1, wherein the sealing film further comprises a side layer extending from the top layer and toward the substrate.

5. The organic light emitting display device as claimed in claim 1, wherein the top layer comprises a plurality of sublayers stacked together, wherein at least part of the plurality of sublayers comprise a nitride material.

6. The organic light emitting display device as claimed in claim 1, wherein the top layer has a thickness of about 0.1 μm to about 1.05 μm.

7. The organic light emitting display device as claimed in claim 1, further comprising a protective film between the organic light emitting diode and the sealing film.

8. The organic light emitting display device as claimed in claim 1, wherein the top layer has a thickness of about 0.05 μm to about 0.1 μm.

9. The organic light emitting display device as claimed in claim 1, wherein the sealing film comprises:
a first organic layer formed over the at least one organic light emitting diode;
a first inorganic layer formed on the first organic layer;
a second organic layer formed on the first inorganic layer; and
a second inorganic layer formed on the second organic layer.

10. The organic light emitting display device as claimed in claim 1, wherein the sealing film has a thickness of about 1 μm to about 10 μm.

11. The organic light emitting display device as claimed in claim 1, wherein the sealing film comprises two or more inorganic layers, wherein at least one organic layer is interposed between two of the inorganic layers.

12. A method of manufacturing an organic light emitting display device comprising:
providing a substrate and at least one organic light emitting diode formed on the substrate; and
forming a film over the at least one organic light emitting diode, wherein the film comprises at least one organic layer and at least one inorganic layer, wherein the film comprises a top layer which is the farthest from the substrate among the layers of the film, and wherein the top layer comprises a nitride material.

13. The method of claim 12, wherein the nitride material is at least one selected from a group consisting of SiN, SiOₓN_{y} and AlOₓN_{y}.

14. The method of claim 12, further comprising forming a protective film over the at least one organic light emitting diode, wherein the protective film is interposed between the at least one organic light emitting diode and the film.

15. The method of claim 12, wherein forming of the film comprises:
forming a first organic layer over the at least one organic light emitting diode;
forming a first inorganic layer on the first organic layer;
forming a second organic layer on the first inorganic layer; and
forming a second inorganic layer on the second organic layer.

16. An organic light emitting display device comprising:
a substrate;
an array of organic light emitting diodes formed on the substrate, wherein the array comprises a top surface and side surfaces; wherein the top surface faces away from the substrate, and wherein the side surfaces interconnect the top surface and the substrate; and
a film, formed over the array, configured to prevent at least one of moisture and oxygen from contacting the array, wherein the film comprises at least one layer, which comprises a nitride material, and wherein the at least one layer comprising the nitride material has a Pencil Hardness value of HB or harder.

17. The device of claim 16, wherein the nitride material is at least one selected from a group consisting of SiN, SiOₓN_{y} and AlOₓN_{y}.

18. The device of claim 16, wherein the top layer has a thickness of about 0.05 μm to about 1.05 μm.

19. The device of claim 16, wherein the Pencil Hardness value is about 9H.

20. The device of claim 16, wherein the film comprises a side layer covering at least part of the side surfaces of the array, wherein the side layer extends from the top layer.
